(19) United States
(12) Patent Application Publication
(10) Pub. No.: US 2003/0056028 A1
(43) Pub. Date: Mar. 20, 2003

(54) Track management system on enterprise java beans

(76) Inventors: Marian Valerie Underwood, Mount Laurel, NJ (US); Christine Marlene Cargado, Palmyra, NJ (US); James Ray Reid, Alpharetta, GA (US)

Correspondence Address: Patent Operation, Lockheed Martin Corporation, Rm. 268 - 2nd Fl., P.O. Box 8048, Philadelphia, PA, 19101, US

(21) Appl. No.: 09/955,863

(22) Filed: Sep. 19, 2001

(51) Int. Cl. G06F 9/00

(52) U.S. Cl. 709/328

(57) ABSTRACT

A command and control system uses J2EE compliant format signals to communicate to the track management system. The track management system operates on an application server arrangement including one or more J2EE compliant application servers. The track management system uses Enterprise Java Beans software components, which are allocated among the various CPUs of the computer processing arrangement by the application server arrangement. Thus, commercial off-the-shelf equipment can be used pursuant to commercial standards to obtain the reliability associated with ready allocation of the Enterprise Java Beans among any of the available CPUs or clusters of CPUs.

### FIELD OF THE INVENTION

This invention relates to command and control systems, and more particularly to track management portions of command and control systems.

### BACKGROUND OF THE INVENTION

Command and control systems are widely used in military applications. In general, a command and control system integrates a plurality of sensors, devices, weapons, and communications with trained people, to accomplish specified functions, both defensive and offensive. The track management system is an important part of a command and control system, in that the data upon which decisions are made by other portions of the command and control system must be correct.

In the past, command and control systems were integrated using various standards, such as LINK 11 and LINK 4A in the case of Navy systems. Such systems can be quite effective. It has been found, however, that such systems are quite expensive to design and manufacture, and are also expensive to maintain and especially to upgrade. The upgrading problem is exacerbated by the fact that the original designers may no longer be available at the time that the upgrade is to be designed. The designers of the upgrade must initially familiarize themselves with the original system before the design of the upgrade can commence, and this time translates into money and delay. In addition, there is a problem of interoperability among the various portions of the redesigned system, in that there must be a consensus among the designers of the various portions of the command and control system as to the data exchange signaling protocols of the redesigned system. This consensus necessarily takes time and additional money.

### SUMMARY OF THE INVENTION

A method according to an aspect of the invention is for operating a command and control system which includes a track management system. The method includes the step of providing a COTS application server arrangement capable of receiving data in a Java Two Enterprise Edition (J2EE) compliant protocol. Target data is generated and communicated to the COTS application server arrangement in the form of a Java Two Enterprise Edition (J2EE) compliant protocol. A plurality of computer processing arrangements are provided, each of which is capable of processing J2EE compliant software components. In other words, the computer processing arrangements are responsive to a COTS application server arrangement. Each computer processing arrangement may be a single CPU (with its ancillary equipment), or a group or cluster of computer processors. Each COTS application server arrangement may be a single application server (with its ancillary software), or a group or cluster of application servers. According to the invention, the method includes, in the application server arrangement, processing the J2EE compliant data with a plurality of Enterprise Java Beans software components. In effect, these are components which are capable of being dynamically controlled. The application server arrangement also establishes those of the computer processing arrangements in which the data is processed. When the computer processing arrangements which are to process the various portions of the data have been established or determined, the J2EE compliant data is provided to the selected ones of the computer processing arrangements, for thereby generating processed data. Finally, the processed data is provided to a user. Most often, the user is another system or subsystem of the command and control system.

A method according to another mode of the invention is for operating a track management system according to another aspect of the invention includes the step of providing a COTS application server arrangement capable of receiving data which is pursuant to a Java Two Enterprise Edition (J2EE) compliant protocol. Data is generated which represents target information, and the data is communicated to the COTS application server in the form of a Java Two Enterprise Edition (J2EE) compliant protocol. A computer processing arrangement is provided. The computer processing arrangement is capable of processing J2EE compliant software components. In the application server arrangement, the J2EE compliant data is processed with one of (a) an Enterprise Java Bean software component arrangement and (b) a Corba software component arrangement, to establish or determine those of the computer processing arrangements in which the data is processed. The J2EE compliant data is provided to the selected ones of the computer processing arrangements, for thereby generating processed data. Finally, the processed data is provided to a user.

### BRIEF DESCRIPTION OF THE DRAWING

FIG. 1 is a simplified block diagram of a command and control system, including a track management system according to an aspect of the invention;

FIG. 2 is a simplified notional or illustrative block diagram of software components of the track management system of FIG. 1;

FIG. 3a represents a simplified block diagram of the allocation of one application server or an application server arrangement to a single computer processing arrangement including a single central processing unit (CPU), FIG. 3b represents a simplified block diagram of the allocation of one application server or application server arrangement to a computer processing arrangement including a plurality of CPUs, FIG. 3c represents a simplified block diagram of the allocation of a plurality of application servers or application server arrangements to a computer processing arrangement including a single CPU, and FIG. 3d represents a simplified block diagram of the allocation of an application server arrangement including a plurality of application servers to a computer processing arrangement including plural CPUs;

FIG. 4a represents a simplified block diagram of the allocation of one Enterprise Java Bean (EJB) software component arrangement including a single EJB software component to an application server arrangement including a single application server, FIG. 4b represents a simplified block diagram of the allocation of one Enterprise Java Bean (EJB) software component arrangement including a single EJB software component to an application server arrangement including a plurality of application servers, FIG. 4c represents a simplified block diagram of the allocation of an EJB software component arrangement including a plurality of EJB software components to an application server arrangement including a single application server, and FIG. 4d represents a simplified block diagram of the allocation of an EJB software component arrangement including a plurality of Enterprise Java Bean software components to an application server arrangement including a plurality of application servers; and

FIG. 5a is a simplified block diagram of a computer processing arrangement capable of processing Java; FIG. 5b is a simplified block diagram of a computer processing arrangement capable of processing Java through a Java virtual machine, FIG. 5c is a simplified block diagram of a computer processing arrangement capable of processing an EJB software component through use of an application server and a Java virtual machine, FIG. 5d is a simplified block diagram of a computer processing arrangement capable of processing an EJB software component through use of an application server, and FIG. 5d is a simplified block diagram of a computer processing arrangement capable of processing a Corba software component by the use of an application server.

### DESCRIPTION OF THE INVENTION

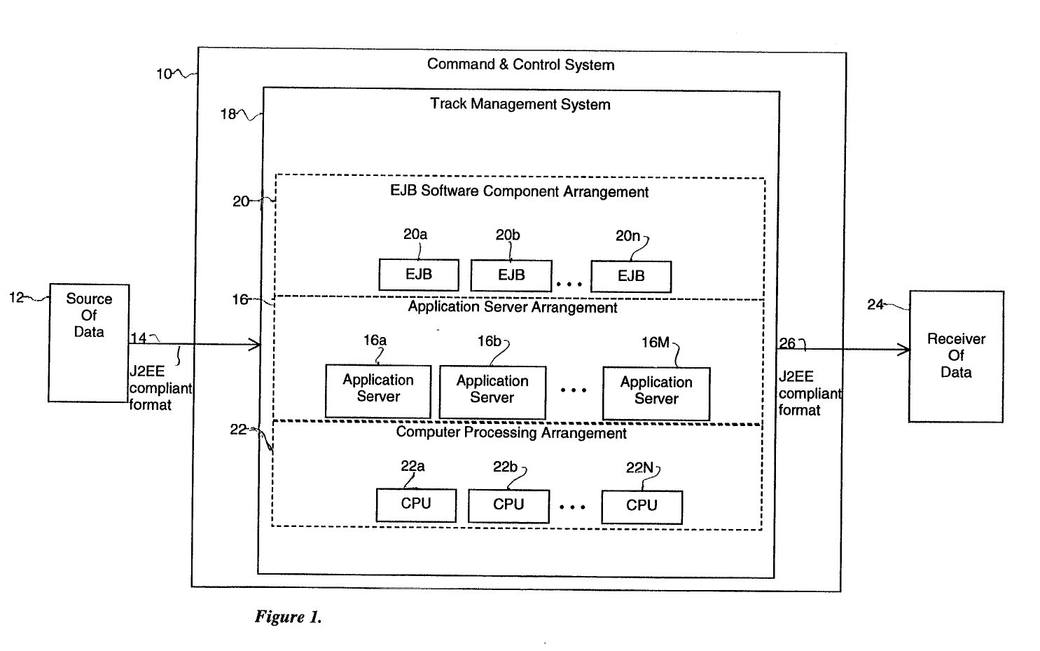

FIG. 1 is a simplified block diagram of a command and control system 10 according to an aspect of the invention. In FIG. 1, a track data source represented as a block 12 generates signals. The source of data 12 may be a sensor or another system or subsystem, which generates signals which may be representative of a the existence of a target or track, and possibly its location, dimensions, and velocity. Source 12 might be a radar system, for example, or another command and control system, or a LINK 4A, Link 11, or LINK 16 interface, or any other source. According to an aspect of the invention, the track data signals are transmitted by way of a signal path 14 to a commercial off-the-shelf (COTS) application server arrangement illustrated as a block 16, and the track data signals on path 14 are in a J2EE-compliant format. In this context, an application server arrangement comprises one or more application servers which provide the application server function. The J2EE format is set or maintained by JavaSoft, which can be found at www.javasoft.com. The set 16 of plural application servers represented by blocks 16a, 16b, . . . , 16M, must be essentially compliant with the J2EE standard, although it is recognized that full compliance is seldom found in any COTS application server. Suitable application servers are (a) Weblogic Enterprise 6.1, manufacture by BEA, whose address is www.bea.com and (b) Power Tier, manufactured by Persistence, whose address is www.persistence.com. Within the application server arrangement 16 of FIG. 1, a track management system 18 receives, processes and maintains the data. In essence, the track management system 18 processes the data for storage, and stores the data. In addition, the track management system determines whether the data represents new data or an update to a current track, all in known fashion. Within the track management system, the data is processed by a set 20 of a plurality of Enterprise Java Bean software components, represented by blocks 20a, 20b, . . . , 20n. The set 20 of plural EJB software components must be essentially compliant with the J2EE standard, although those skilled in the art will recognize that the compliance need only be sufficient for operation as described herein. Physically, the application server arrangement 16 includes a plurality of central processing units, which are represented by a set 22 of blocks 22a, 22b, . . . , 22N, where N need not equal n. Instead of individual CPUs, some or all of the blocks of set 22 may be clusters of CPUs. Instead of individual application servers, some or all of the blocks of set 16 may be clusters of application servers. Instead of individual EJB software components, some or all of the blocks of set 20 may be a plurality of EJB software components. According to an aspect of the invention, the application server arrangement establishes or determines which Enterprise Java Bean software component of set 20 runs on which of the CPUs 22a, 22b, . . . , 22N.

As also illustrated in FIG. 1, application server 16a may be a part of an application server arrangement 16 which includes a plurality of application servers, some of which are additionally designated 16b, 16M.

Upon requests for data from an external user of data, such as user 24 of FIG. 1, the requested data is transmitted, in J2EE compliant format, to the user. The user block which receives the signals may be a sensor, a weapon, or another system or subsystem. The inherent operation of the application server arrangement 16 operating on the Enterprise Java Beans, and in conjunction with the plurality of CPUs of set 22, results in automatic assignment of each Enterprise Java Bean component to one of the processors. In the event of failure of one of the CPUs of set 22, the application server arrangement 16 automatically reassigns the Enterprise Java Beans to operable processors, unlike the situation in the prior art, in which failure of as few as two CPUs, namely (a) the primary and (b) the secondary or backup could result in failure to run of that software process which was assigned to those two CPUs.

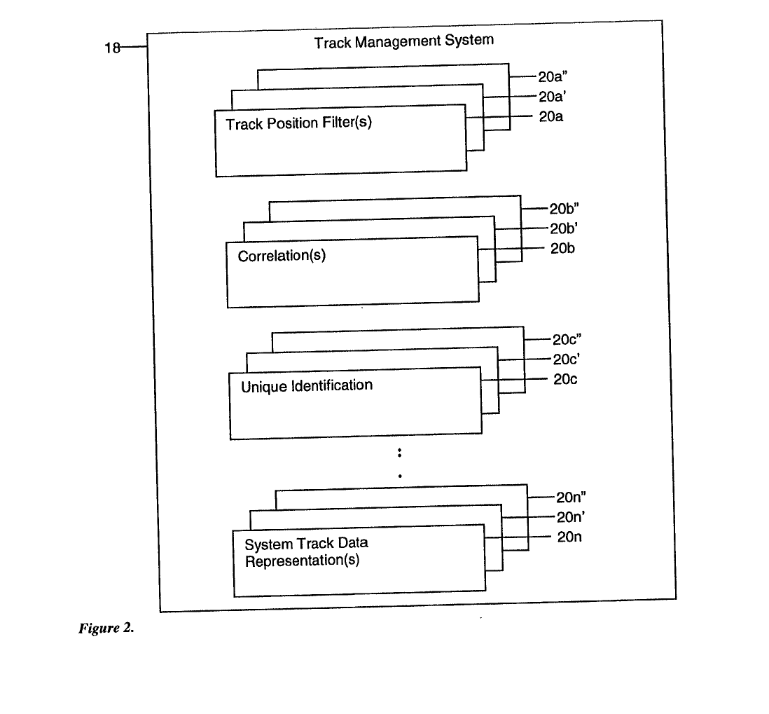

In FIG. 2, track management system 18 is illustrated as including a plurality of track position filter components 220a, 220a′, . . . 220a″, . . . , 220a^{N}. Each track position filter component translates the coordinate information for each track to a common coordinate system. Track management system 18 of FIG. 2 also includes a plurality of correlators or correlation components, some of which are designated 220b, 220b′, and 220b″. A correlator determines whether new data received represents a new manifestation of a track which is currently in the data base, or if it is a new entity which should be independently processed. Track management system 18 also includes a plurality of unique identification components 220c, 220c′, and 220c″ and of system track data representation components 220n, 220n′, and 220n″. The number of each component which may be in existence at any particular moment depends upon the number of individual processes which are being prosecuted, which in turn means that the number of components such as 220a, 220b, 220c, or 220d (or any others which may be used) equals the number of Enterprise Java Beans currently in existence. In other words, the track position filters, correlators, unique identifiers, and system track data representations of FIG. 2 are merely particular uses or implementations of the EJBs of FIG. 1. The components of the track management system, and their functions, are well known in the art, and form no part of the invention.

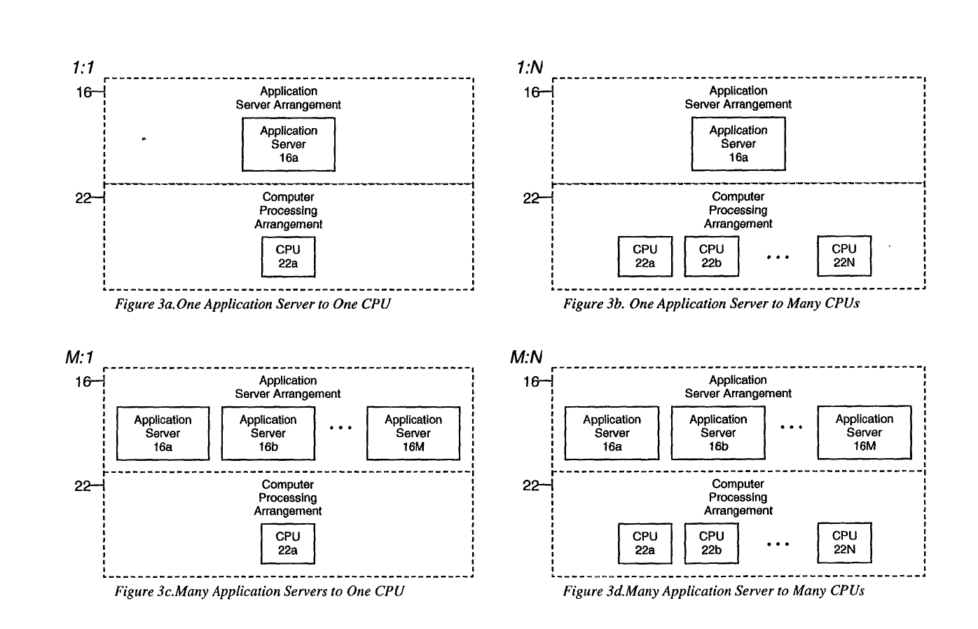

In general, any number of application server(s) may be associated with any number of computer processing arrangements. A computer processing arrangement capable of processing J2EE compliant software components must be capable of one of (a) processing Java code, (b) processing Java byte code, (c) processing Java byte code through use of a Java virtual machine or its functional equivalent, (d) processing EJB software components, (e) processing EJB software components through use of an application server arrangement, or (f) processing Corba software components , since Corba software components, which are functionally equivalent to EJB software components. In FIG. 3a, a single application server designated 16a is associated with a single computer processing arrangement 22a in a “1:1” arrangement. As noted, a computer processing arrangement may include a cluster having a plurality of central processing units. In FIG. 3b, a single application server designated 16a is associated with a plurality of computer processing arrangements, designated 16a, 16b, . . . , 16N, in a “1:N” relationship. In FIG. 3c, application servers 16a, 16b, . . . , 16n are associated with a single computer processing arrangement 22a in an “n:1” arrangement. Lastly, in FIG. 3d, a plurality of application servers designated 16a, 16b, . . . , 16n are associated with a plurality of computer processing arrangements 16a, 16b, . . . , 16N. Thus, the invention allows independence of the allocation of the underlying computer processing arrangement so long as the underlying computer processing arrangements are responsive to COTS application server arrangements.

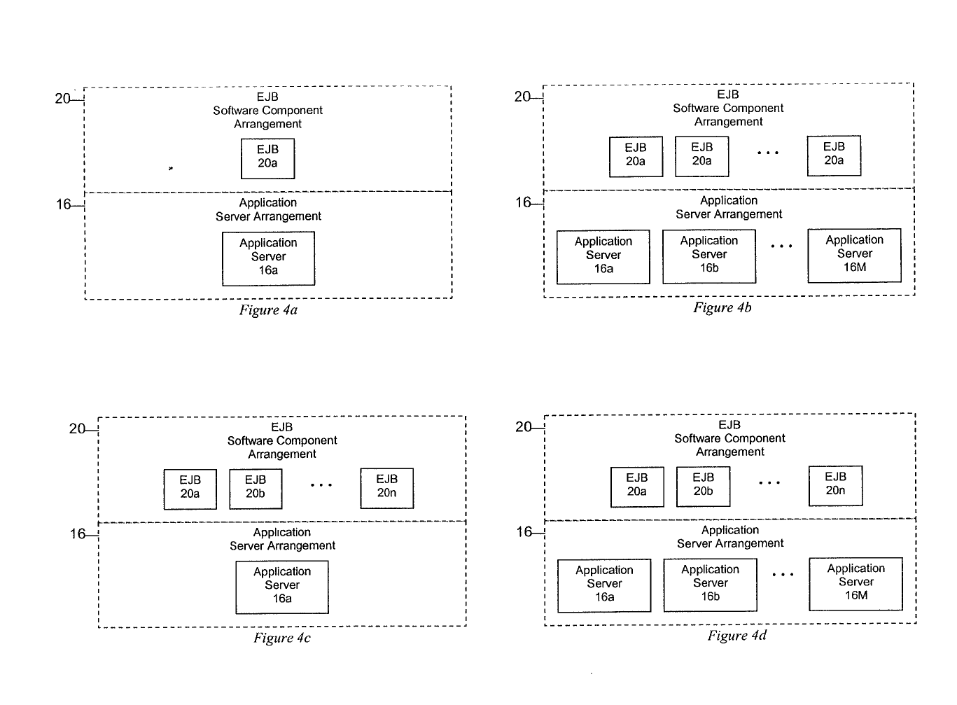

In general, any number of Enterprise Java Bean(s) may be associated with any number of application servers. In FIG. 4a, a single Enterprise Java Bean designated 20a is associated with an application server arrangement 16 containing but a single application server 16a in a “1:1” arrangement. In FIG. 4b, many similar Enterprise Java Bean software components represented by blocks labelled 20a are associated with an application server arrangement 16 including a plurality of application servers designated 16a, 16b, . . . , 16N in a “1:N” relationship. In FIG. 4c, Enterprise Java Beans 20a, 20b, . . . , 20n are associated with an application server arrangement 16 containing a single application server 16a in an “n:1” arrangement. Lastly, in FIG. 4d, a plurality of Enterprise Java Beans designated 20a, 20b, . . . , 20n are associated with an application server arrangement 16 including a plurality of application servers 16a, 16b, . . . , 16M. Thus, the invention allows independence of the allocation of the application servers of the application server arrangements with the Enterprise Java Beans so long as the underlying computer processing arrangements are responsive to COTS application server arrangements.

The invention has the advantage of avoiding the need to maintain a store or archive of documentation relating to a plurality of proprietary interconnection standards such as those used in prior-art systems. Often, this documentation was out-of-date, and did not match the actual current practice. Instead, according to the invention, the standards are maintained by the industry groups, and so long as the equipments conform to the industry standards, any designer can use the standards to upgrade, enhance or repair a command and control system according to the invention.

In addition to the above advantages, the system according to the invention has the additional advantage, by comparison with prior art systems such as the AEGIS weapon system, of providing the ability to dynamically activate or deactivate software components. Further, the processing of software components can be dynamically reallocated or redistributed among processors andor computer processing arrangements. Since systems according to the invention are J2EE compliant, various systems tools such a development and debugging tools, peripherals, and other software components, are readily available. Put another way, systems according to the invention, by contrast with at least some prior art systems, have the flexibility andor capability to rebalance operation in the event of faults or improper load distribution, because the applications operated by the software components are independent of the hardware processors on which the components run.

Those skilled in the art recognize that an application server could be used even if it did not run on a Java virtual machine, but could process the data in the desired fashion and produce the desired results even if it were to run on binary files which execute the machine code, so long as the end computer processing arrangement or CPU is capable of being controlled by the application server. Thus, an application server running C++ could process the Enterprise Java Beans. Corba software components are functionally equivalent to EJB software components, and may be used in their stead. In general, it is recognized that the technologies in question tend to be combined into assemblages of greater and greater complexity, so that systems including separate or several functional blocks tend to be combined into single blocks or elements which include all the functions of the formerly separate entities. It is anticipated that the system according to the invention may be implemented as a single integrated block lacking obvious separations among the functional elements. In order to use Java byte code, one must necessarily use a J2EE.

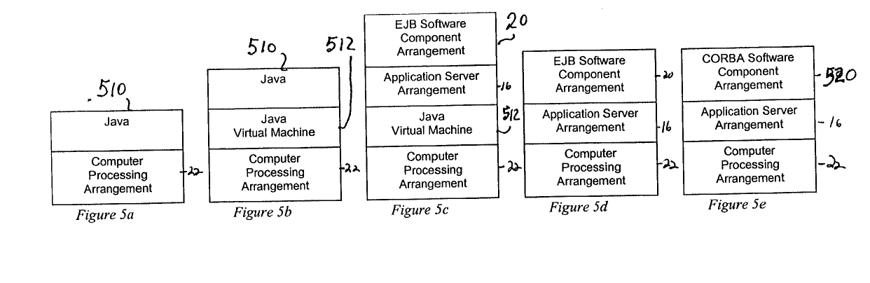

FIG. 5a is a simplified block diagram of a computer processing arrangement 22 capable of processing Java software component 510. The Java software component should be one of (a) Java code, (b) Java byte code, (c) andor machine code derived from Java code. FIG. 5b is a simplified block diagram of a computer processing arrangement 22 capable of processing Java 510 through a Java virtual machine 512. FIG. 5c is a simplified block diagram of a computer processing arrangement 22 capable of processing an EJB software component or software component arrangement 20 through use of an application server or application server arrangement 16 and a Java virtual machine 512. FIG. 5d is a simplified block diagram of a computer processing arrangement 22 capable of processing an EJB software component or EJB software component arrangement 20 through use of an application server or application server arrangement 16. FIG. 5d is a simplified block diagram of a computer processing arrangement 22 capable of processing a Corba software component or Corba software component arrangement 520 by the use of an application server or application server arrangement 16.

Thus, the computer processing arrangement capable of processing J2EE compliant software components entails at least one of (a) processing Java code, (b) processing Java byte code, (c) processing Java byte code through use of a Java virtual machine or its functional equivalent, (d) processing EJB software components, (e) processing EJB software components through use of an application server, and (f) processing Corba software components, given that such components are functionally equivalent to EJB software components.

Thus, a method according to an aspect of the invention is for operating a command and control system (10) which includes a track management system (18). The method includes the step of providing one or more commercial off-the-shelf (COTS) application server(s) (16a; 16a, 16b, . . . , 16M) capable of receiving data in a Java Two Enterprise Edition (J2EE) compliant protocol. Target or other data is generated (12) and communicated to the COTS application server arrangement (16) in the form of a Java Two Enterprise Edition (J2EE) compliant protocol. A plurality (22) of computer processing arrangements (22a, 22b, . . . , 22N) are provided, each of which is capable of processing J2EE compliant software components. In other words, the computer processing arrangements (22a, 22b, . . . , 22N) are responsive to a COTS application server arrangement. Each computer processing arrangement (22a, 22b, . . . , 22N) may be a single CPU (with its ancillary equipment), or a group or cluster of computer processors. According to the invention, the method includes, in the application server arrangement (16), processing the J2EE compliant data with a plurality of Enterprise Java Beans software components (20a, 20b, . . . 20n). In effect, these are components which are capable of being dynamically controlled. The application server arrangement (16) also establishes or determines those of the computer processing arrangements (22a, 22b, . . . , 22N) in which the data is processed. When the computer processing arrangements (22a, 22b, . . . , 22N) which are to process the various portions of the data have been established or determined, the J2EE compliant data is provided to the selected ones of the computer processing arrangements (22a, 22b, . . . , 22N), for thereby generating processed data (on path 26). Finally, the processed data is provided to a user (24). Most often, the user (24) is another system or subsystem of the command and control system (10).

A method for operating a track management system (18) according to another aspect of the invention includes the step of providing a COTS application server arrangement (16a; 16a, 16b, . . . , 16M) capable of receiving data which is pursuant to a Java Two Enterprise Edition (J2EE) compliant protocol. Data is generated which represents target information, and the data is communicated to the COTS application server in the form of a Java Two Enterprise Edition (J2EE) compliant protocol. A computer processing arrangement (22a, 22b, . . . , 22N) is provided. The computer processing arrangement is capable of processing J2EE compliant software components. In the application server arrangement, the J2EE compliant data is processed with one of (a) an Enterprise Java Bean software component arrangement and (b) a Corba software component arrangement, to establish or determine those of the computer processing arrangements in which the data is processed. The J2EE compliant data is provided to the selected ones of the computer processing arrangements, for thereby generating processed data. Finally, the processed data is provided to a user.

What is claimed is:

1. A method for operating a track management system, said method comprising the steps of:
providing a COTS application server capable of receiving data in a Java Two Enterprise Edition (J2EE) compliant protocol;
generating data representing target information, and communicating said data to said COTS application server in the form of a Java Two Enterprise Edition (J2EE) compliant protocol;
providing a plurality of computer processing arrangements, each of which is capable of processing Java;
in said application server, processing said J2EE compliant data with a plurality of Enterprise Java Beans software components, establishing those of said computer processing arrangements in which said data is processed;
providing said J2EE compliant data to the selected ones of said computer processing arrangements, for thereby generating processed data; and
providing said processed data to a user.

2. A method for operating a track management system, said method comprising the steps of:
providing a COTS application server arrangement capable of receiving data in a Java Two Enterprise Edition (J2EE) compliant protocol;
generating data representing target information, and communicating said data to said COTS application server in the form of a Java Two Enterprise Edition (J2EE) compliant protocol;
providing a computer processing arrangement which is capable of processing J2EE compliant software components;
in said application server arrangement, processing said J2EE compliant data with one of (a) an Enterprise Java Bean software component arrangement and (b) a Corba software component arrangement to establish those of said computer processing arrangements in which said data is processed;
providing said J2EE compliant data to the selected ones of said computer processing arrangements, for thereby generating processed data; and
providing said processed data to a user.
